(19) United States
(12) Patent Application Publication
(10) Pub. No.: US 2025/0076784 A1
(43) Pub. Date: Mar. 6, 2025

(54) CHIP MODULE OF TONER CARTRIDGE

(71) Applicant: GENERAL PLASTIC INDUSTRIAL CO., LTD., Taichung City (TW)

(72) Inventor: Kuan-Tung LI, Taichung City (TW)

(73) Assignee: GENERAL PLASTIC INDUSTRIAL CO., LTD., Taichung City (TW)

(21) Appl. No.: 18/242,815

(22) Filed: Sep. 6, 2023

(51) Int. Cl. G03G 15/08

(52) U.S. Cl. CPC G03G 15/0863

(57) ABSTRACT

A chip module of a toner cartridge is used to be coupled to an electronic image-forming apparatus including a reading head having communication conductive strips and a grounding conductive strip. The chip module includes a substrate, a memory mounted to the substrate, and terminals mounted to the substrate and electrically connected with the memory. Each terminal includes a sheet body parallel to an imaginary plane, two lateral sides respectively located at two opposite sides of the sheet body and parallel to the imaginary plane, and an arched contact edge located at a lateral edge of the sheet body and between the two lateral sides for being contacted with one of the communication conductive strips and the grounding conductive strip. As such, the chip module can be positively aligned and contacted with the reading head of the electronic image-forming apparatus.

### BACKGROUND OF THE INVENTION

### 1. Field of the Invention

The present invention relates generally to an electronic image-forming apparatus and more particularly, to a chip module of a toner cartridge for being used in an electronic image-forming apparatus.

### 2. Description of the Related Art

An electronic image-forming apparatus, such as photocopier, printer, etc., is generally quipped with a replaceable toner cartridge therein. The front end of the toner cartridge is provided with a chip module, which is used to contact a reading head of the electronic image-forming apparatus for communication of relevant information. The reading head has a base, several communication conductive strips, and a grounding conductive strip. To align the chip module of the toner cartridge with the reading head accurately, a protruding post is provided on the base, the grounding conductive strip is provided at the lateral edge of the protruding post, and the communication conductive strips are arranged by two lateral sides of the protruding post. Correspondingly, the chip module is provided with an alignment structure. Since the toner cartridge is a consumable item, it needs to be replaced when the toner is exhausted out. Therefore, designing an alignment structure of the chip module to ensure that each newly inserted toner cartridge can be positively aligned and contacted with the reading head of the electronic image-forming apparatus under a condition of low manufacturing cost to alleviate consumers' burden has become a technical challenge that the industry is striving to overcome.

### SUMMARY OF THE INVENTION

The present invention has been accomplished in view of the above-noted circumstances. It is an objective of the present invention to provide a chip module of a toner cartridge that can be positively aligned and contacted with a reading head of an electric image-forming apparatus.

It is another objective of the present invention to provide a chip module of a toner cartridge, which has a low manufacturing cost, thereby alleviating the burden on consumers.

To attain the above-mentioned objectives, the present invention provides a chip module of a toner cartridge for being coupled to an electronic image-forming apparatus including a reading head having communication conductive strips and a grounding conductive strip. The chip module comprises a substrate, a memory mounted to the substrate, and terminals mounted to the substrate and electrically connected with the memory. Each terminal comprises a sheet body parallel to an imaginary plane, two lateral sides respectively located at two opposite sides of the sheet body and parallel to the imaginary plane, and an arched contact edge located at a lateral edge of the sheet body and between the two lateral sides for being contacted with one of the communication conductive strips and the grounding conductive strip. As such, the chip module can be positively aligned and contacted with the reading head of the electronic image-forming apparatus, and can be made with low manufacturing cost to alleviate the consumer's burden.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a toner cartridge according to an embodiment of the present invention;

FIG. 2 is a partially exploded perspective view of the toner cartridge of the embodiment of the present invention;

FIG. 3 is a perspective view of a chip module of the toner cartridge of the embodiment of the present invention;

FIG. 4 is an exploded perspective view of the chip module of the toner cartridge of the embodiment of the present invention;

FIG. 5 is another perspective view of the chip module of the toner cartridge of the embodiment of the present invention;

FIG. 6 is a perspective view showing that the chip module of the toner cartridge is coupled with a reading head; and

FIGS. 7-9 are partially cutaway perspective views showing that the chip module of the toner cartridge is coupled with the reading head.

### DETAILED DESCRIPTION OF THE INVENTION

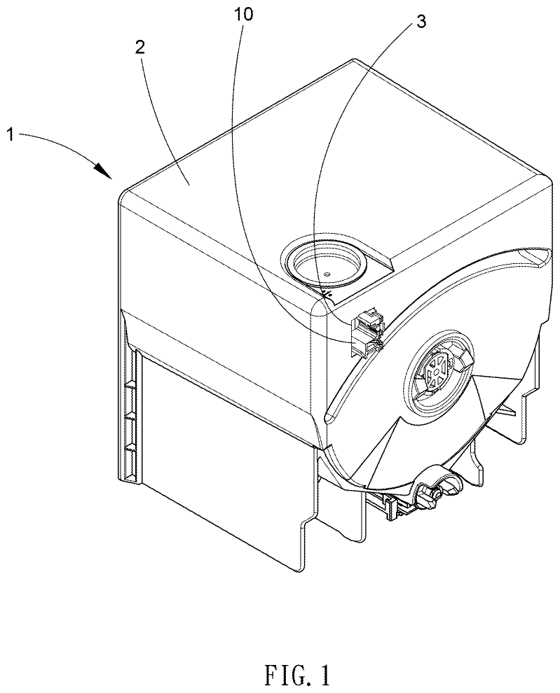

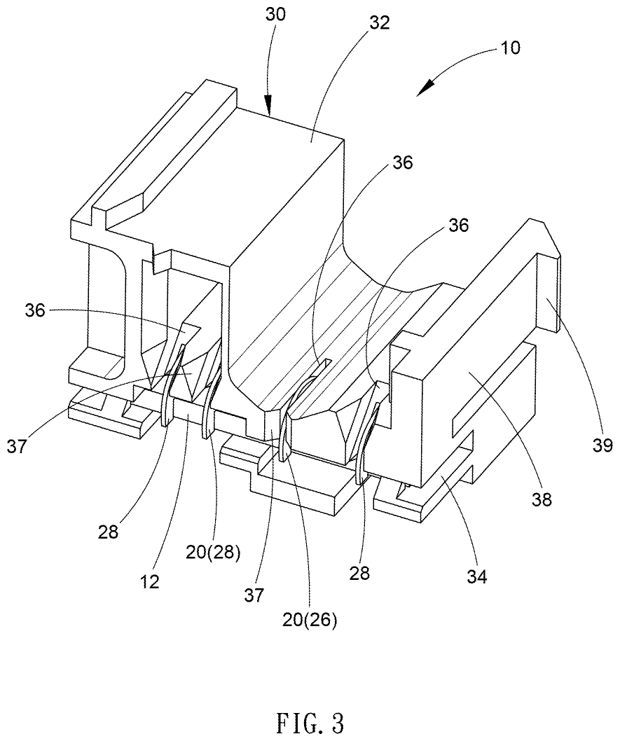

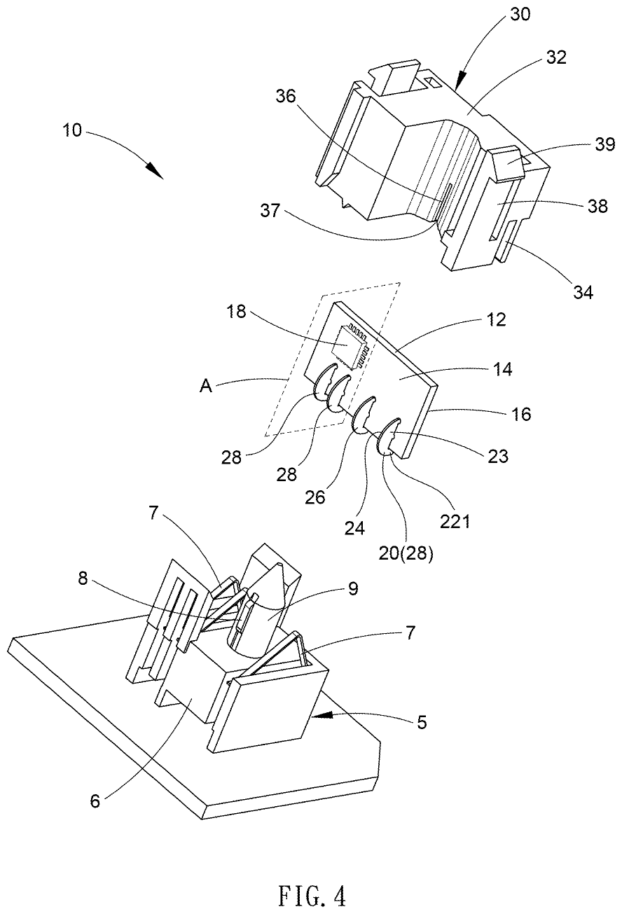

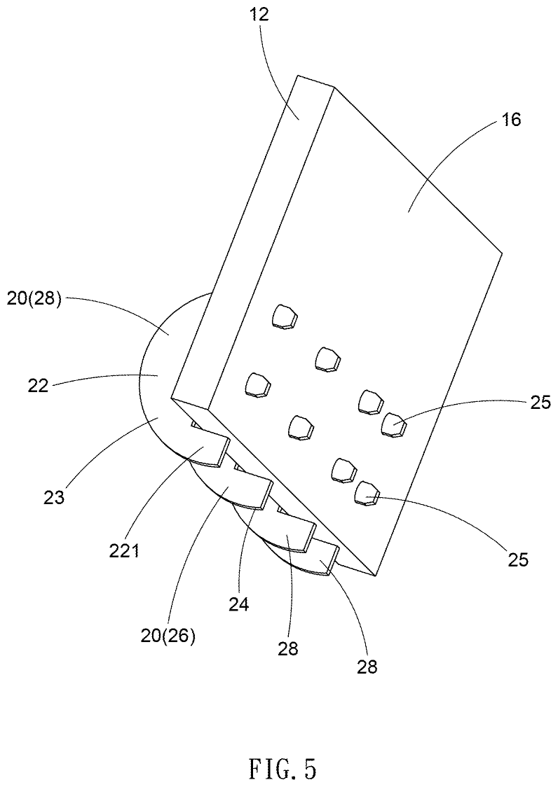

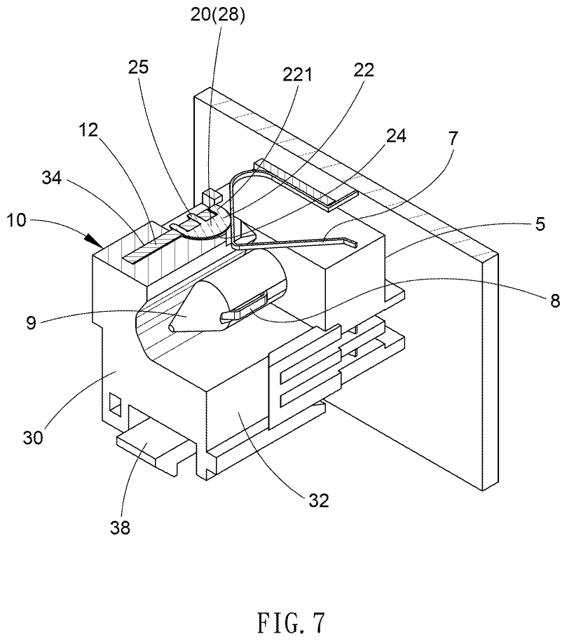

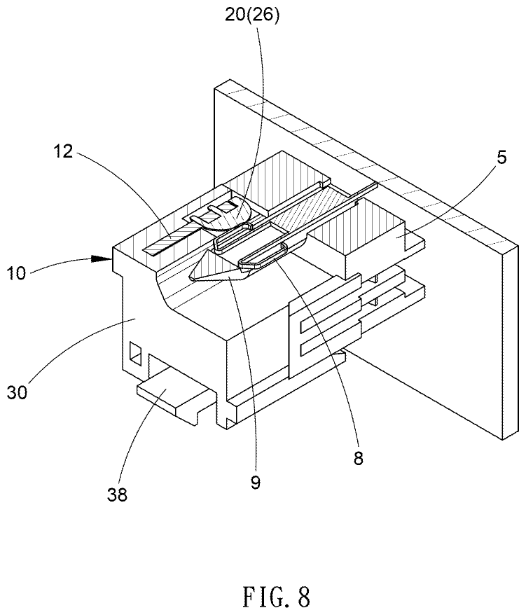

Hereunder an embodiment will be detailedly described with accompanying drawings for illustrating technical features and structure of the present invention. FIGS. 1-5 depict a chip module 10 of a toner cartridge 1 in accordance with an embodiment of the present application. The chip module 10 is positioned at the front end of the toner cartridge 1. When the toner cartridge 1 is inserted into an electronic image-forming apparatus (not shown), the chip module 10 is in contact with a reading head 5 of the electronic image-forming apparatus to facilitate message transmission between the toner cartridge 1 and the electronic image-forming apparatus. The toner cartridge 1 is composed of a housing 2 provided with an engagement slot 3. The reading head 5 includes a base 6, three communication conductive strips 7, and a grounding conductive strip 8. The base 6 is provided with a protruding post 9 located between the three communication conductive strips 7, and the grounding conductive strip 8 has two exposed portions, as shown in FIG. 8, positioned at two lateral sides of the protruding post 9. It is to be noted that in FIGS. 4 and 6-7, only one exposed portion of the grounding conductive strip 8 is shown. Both the communication conductive strips 7 and the grounding conductive strip 8 can experience elastic deformation when they receive external force thereon. The chip module 10 comprises a substrate 12, a memory 18, four terminals 20, and a connecting frame 30.

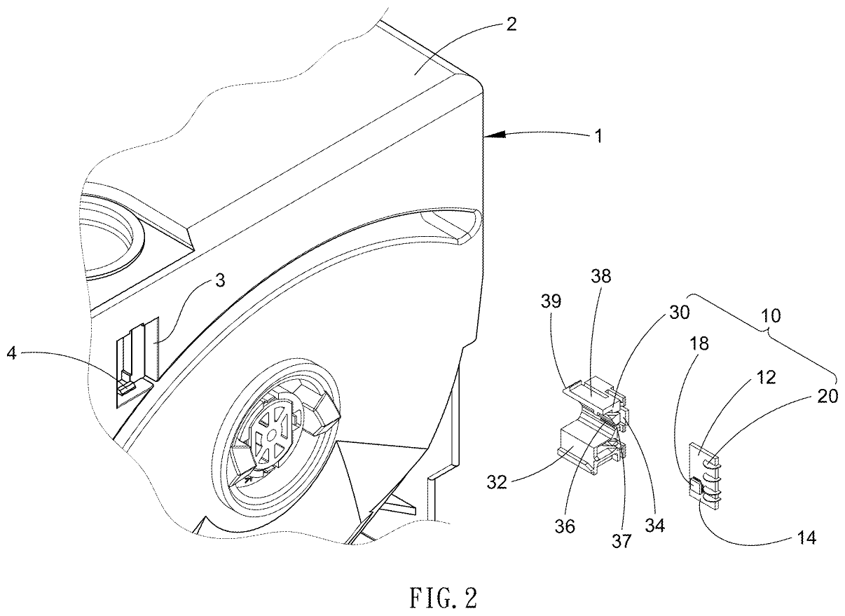

As shown in FIGS. 2, 4, and 5, the substrate 12 is a printed circuit board having a top surface 14 and a bottom surface 16. The memory 18 is mounted on the top surface 14 of the substrate 12. In another embodiment, the memory 18 can be positioned on the bottom surface 16 of the substrate 12.

The terminals 20 are mounted on the top surface 14 of the substrate 12 and electrically connected with the memory 18. Each terminal 20 comprises a sheet body 22 oriented parallel to an imaginary plane A, two lateral sides 23 located on two opposite sides of the body 22 and parallel to the imaginary plane A, an arched contact edge 24 located at a lateral edge of the body 22, and two contact pins 25 extending from the body 22 and penetrating through the substrate 12. The imaginary plane A is approximately perpendicular to the substrate 12, and each contact edge 24 is located between the corresponding two lateral sides 23, forming a semicircular shape. In this embodiment, the body 22 includes an extension portion 221, such that the contact edge 24 extends from the top surface 14 of the substrate 12 towards the lateral side of the substrate 12. However, in another embodiment, the body 22 may be configured without extending to the lateral side of the substrate 12. That is, the body 22 may have a semicircular shape without the extension portion 221. Although the terminals 20 have a similar appearance, they are composed of a grounding terminal 26 and three transmission terminals 28. The grounding terminal 26 is positioned between the three transmission terminals 28 and corresponds to the grounding conductive strip 8 of the reading head 5, while the positions of the three transmission terminals 28 correspond respectively to the three communication conductive strips 7 of the reading head 5.

As shown in FIGS. 2-4, the connecting frame 30 is used to connect the substrate 12 with the toner cartridge 1. The connecting frame 30 includes a main body 32, a receiving groove 34 recessed inward from one side of the main body 32, four guide grooves 36 parallel to each other and communicated with the receiving groove 34, and two resilient arms 38 extending outward from two opposite sides of the main body 32 towards the engagement slot 3. The receiving groove 34 is used to accommodate the substrate 12 of the chip module 10 therein, and the guide grooves 36 are configured allowing that the contact edges 24 of the terminals 20 extend into the guide grooves 36, respectively. The openings 37 of these guide grooves 36 are funnel-shaped, gradually narrowing from outer end toward inner end thereof. This design assists in guiding the grounding conductive strip 8 and communication conductive strips 7 of the reading head 5 to align accurately with the terminals 20. Each resilient arm 38 is equipped with a hook portion 39 at the terminal end thereof, which can be hooked onto one of the two coupling blocks 4 of the engagement slot 3, thereby securely coupling the connecting frame 30 with the housing 2.

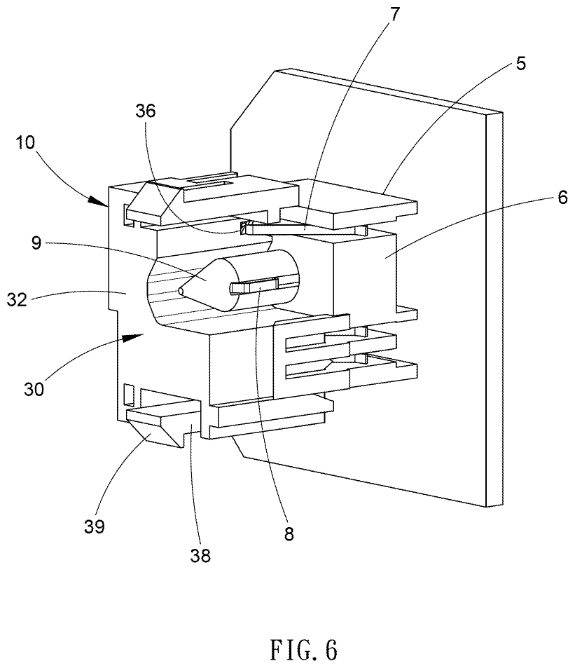

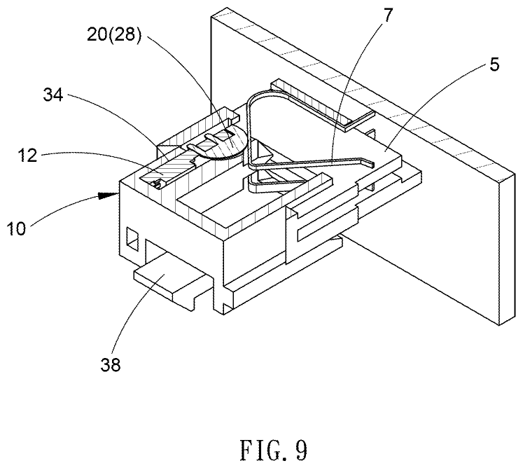

With the above-described features, when the toner cartridge 1 is inserted into the electronic image-forming apparatus, the chip module 10 located at the front end of the toner cartridge 1 is in contact with the reading head 5, as shown in FIGS. 6-9. In this arrangement, the grounding terminal 26 is in contact with the grounding conductive strip 8, and the three transmission terminals 28 are in contact with the three communication conductive strips 7, respectively. Since the contact edges 24 are arched and the grounding conductive strip 8 and communication conductive strips 7 can undergo elastic deformation, even if the grounding conductive strip 8 and communication conductive strips 7 are made having great manufacturing tolerances or become deformation due to long-term use, it can still ensure accurate alignment and contact between the contact edges 24 of the terminals 20 and the grounding conductive strip 8 or communication conductive strips 7. Additionally, due to the substantial thickness of the body 22, the contact edges 24 can be contacted with both the communication conductive strips 7 and the grounding conductive strip 8 in a line contact manner, preventing issues of excessive localized current or poor contact. Furthermore, since the grounding terminal 26 and the three transmission terminals 28 have the same shape and the same assembly structure for being installed with the substrate 12, they can be made and assembled by the same molds or jigs. This not only reduces manufacturing costs but also alleviates the burden on consumers, enhancing market competitiveness.

Based on the above-mentioned technical features, various modifications to the structure of the chip module 10 may be made. For example, each terminal 20 may have one or more contact pins 25 disposed on the substrate 12. The imaginary plane A may not necessarily need to be perpendicular to the substrate 12. The contact edges 24 may be configured having an arched shape, i.e., not required to have a semicircular shape. The quantity of the terminals 20 can vary based on the number of communication conductive strips and grounding conductive strip of the reading head. Such variations are not to be regarded as a departure from the spirit and scope of the invention, and all such modifications as would be obvious to one skilled in the art are intended to be included within the scope of the following claims.

What is claimed is:

1. A chip module of a toner cartridge, comprising:
a substrate;
a memory mounted to the substrate; and
a plurality of terminals mounted to the substrate and electrically connected with the memory;
wherein each of the terminals comprises a sheet body parallel to an imaginary plane, two lateral sides respectively located at two opposite sides of the sheet body and parallel to the imaginary plane, and an arched contact edge located at a lateral edge of the sheet body and between the two lateral sides.

2. The chip module of the toner cartridge as claimed in claim 1, wherein each of the terminals comprises at least one contact pin extending from the sheet body and being disposed to the substrate.

3. The chip module of the toner cartridge as claimed in claim 1, wherein the terminals comprise a grounding terminal, and a plurality of transmission terminals.

4. The chip module of the toner cartridge as claimed in claim 1, wherein the substrate is substantially perpendicular to the imaginary plane.

5. The chip module of the toner cartridge as claimed in claim 1, wherein the arched contact edge of each of the terminals has a semicircular shape.

6. A chip module of a toner cartridge for being coupled to an electronic image-forming apparatus, the electronic image-forming apparatus comprising a reading head including a plurality of communication conductive strips and a grounding conductive strip, the chip module of the toner cartridge comprising:
a substrate;
a memory mounted to the substrate; and
a plurality of terminals mounted to the substrate and electrically connected with the memory;
wherein each of the terminals comprises a sheet body parallel to an imaginary plane, two lateral sides respectively located at two opposite sides of the sheet body and parallel to the imaginary plane, and an arched contact edge located at a lateral edge of the sheet body and between the two lateral sides for being contacted with one of the communication conductive strips and the grounding conductive strip.

7. The chip module of the toner cartridge as claimed in claim 6, wherein the arched contact edges of the terminals are respectively contacted with the communication conductive strips and the grounding conductive strip in a line contact manner.

8. The chip module of the toner cartridge as claimed in claim 6, wherein each of the terminals comprises at least one contact pin extending from the sheet body and being disposed to the substrate.

9. The chip module of the toner cartridge as claimed in claim 6, wherein the terminals comprise a grounding terminal, and a plurality of transmission terminals; the grounding terminal is adapted for being contacted with the grounding conductive strip of the reading head, and the transmission terminals are adapted for being contacted with the communication conductive strips of the reading head.

10. The chip module of the toner cartridge as claimed in claim 6, wherein the substrate is substantially perpendicular to the imaginary plane.

11. The chip module of the toner cartridge as claimed in claim 6, wherein the arched contact edge of each of the terminals has a semicircular shape.
